(19) United States
(12) Patent Application Publication
(10) Pub. No.: US 2004/0251240 A1
(43) Pub. Date: Dec. 16, 2004

(54) Method and apparatus for treating a surface using a plasma discharge

(75) Inventors: Scott Joseph Simon, Bristol (GB); John Eric Dolan, Bristol (GB)

Correspondence Address: BURNS DOANE SWECKER & MATHIS L L P, POST OFFICE BOX 1404, ALEXANDRIA, VA, 22313-1404, US

(73) Assignee: BAE Systems PLC

(21) Appl. No.: 10/848,499

(22) Filed: May 18, 2004

(30) Foreign Application Priority Data
Apr. 10, 2003 (GB) 0308192.4
Apr. 10, 2003 (EP) 03252266.6

(51) Int. Cl. B23K 10/00

(52) U.S. Cl. 219/121.41; 219/121.4

(57) ABSTRACT

Apparatus for treating a surface using a plasma discharge includes a first capacitor electrode of a first capacitor; a second capacitor electrode of a second capacitor; and an electrical connection for connecting the first capacitor electrode to the second capacitor electrode. The first capacitor electrode and second capacitor electrode are disposed in juxtaposition.

### RELATED APPLICATIONS

This application is a continuation of International Application No. PCT/GB2004/001519, filed on Apr. 7, 2004, the entire disclosure of which is incorporated by reference.

### BACKGROUND

This invention relates to apparatus for treating a surface using a plasma discharge and to a method of operating such an apparatus.

The use of plasma discharges in treating surfaces is well established. For example, plasma discharges may be used to clean, to coat or to roughen a surface. This may be done as a precursor to a further treatment. It has been found that plasma-cleaned surfaces offer greater corrosion resistance when subsequently electroplated. In addition, plasma-cleaned surfaces offer greater adhesion for electroplated layers, paint layer and for adhesives themselves.

A conventional apparatus used for plasma-treatment of surfaces is shown in FIG. 1a. An electrode provided on a dielectric (e.g. glass, quartz or a ceramic such as alumina) is brought into close proximity to the surface of a workpiece to be treated, leaving typically a 1 mm gap between the dielectric and the workpiece. The equivalent circuit is illustrated in FIG. 1b. An electrical connection is made to the workpiece such that the workpiece becomes the second electrode of a capacitor. A high-voltage ac power supply is used to apply a voltage of typically 5-10 kV on the first electrode. Current will then flow across the capacitor and through the workpiece to the electrical connection that has been made and back to the power supply. The current flowing across the capacitor causes a plasma discharge that causes the surface to be treated. Where the surface to be treated is not electrically conducting, the method is still applicable where there is a conducting layer beneath the surface to which an electrical connection can be made. An example of such an apparatus is disclosed in U.S. Pat. No. 5,938,854.

The above apparatus for and method of treating a surface suffer from several disadvantages. For example, it is often difficult to make a satisfactory electrical connection to the workpiece. In exceptional circumstances, the workpiece may have an upstanding part to which a simple electrical connection can be made (such as a crocodile clip or the like). However, it is more likely that the surface to be cleaned will be flat (e.g. the external surface of an automobile, airplane or other vehicle prior to painting) and so making electrical connection requires adhering a contact to the surface which may mark or damage the surface. Moreover, it may be difficult to make an electrical contact close to the area of the surface to be cleaned. This means that long electrical paths through the workpiece result which are undesirable, as will be explained below.

There are many items that are unsuitable for direct connection to a high voltage power supply. Such items may contain sensitive electronic equipment that will be adversely affected by current flow nearby. In addition, a large item such as a ship may introduce a high inductance in the current loop or may be impossible to isolate from earth such that multiple current loops arise. Moreover, there is always a danger in making a direct electrical connection to a workpiece and thereby instigating a current path through the workpiece in that large parts of the workpiece may rise to an elevated potential and this introduces the hazard of electrical shocks.

### SUMMARY

Against this background, and from a first aspect, the present invention resides in an apparatus for treating a surface using a plasma discharge comprising: a first capacitor electrode of a first capacitor; a second capacitor electrode of a second capacitor; and an electrical connector for connecting the first capacitor electrode to the second capacitor electrode, wherein the first capacitor electrode and second capacitor electrode are disposed in juxtaposition.

Such an apparatus may be brought close to a workpiece, such that the first and second capacitor electrodes face a surface of the workpiece to be treated, and operated such that current flows around a circuit as follows: current may flow from a power supply along the electrical connector to the first capacitor electrode, across a first capacitive gap between the first capacitor electrode and the workpiece, along the surface of the workpiece between the parts that face the first and second capacitor electrodes, across a second capacitive gap between the workpiece and the second capacitor electrode and back to the power supply along the electrical connector. Accordingly, the surface of the workpiece provides an electrical path linking the capacitor electrodes. Provided the power supply is operated at a sufficiently high voltage, plasma will be produced at both the first and second capacitive gaps thereby treating the surface. Advantageously, there is no requirement for a direct electrical connection to the workpiece. Furthermore, the current flow through the workpiece will be localized to the vicinity of the first and second capacitor electrodes. Hence, the need to find a convenient location for making electrical connection to the workpiece is obviated and the disadvantage of long and widespread current paths through the workpiece can be effectively removed. In addition, the apparatus can be compact and self-contained and so may be moved quickly and easily to any accessible part of the workpiece.

The term “juxtaposed” is to be given a broad construction to cover any side-by-side arrangement. For example, the first capacitor electrode may be disposed entirely to one side of the second capacitor electrode such that only a single pair of edges are arranged side-by-side: an example of such an arrangement is shown in FIGS. 2a and 3. Alternatively, more than a single pair of edges may be arranged to be side-by-side. For example, the second capacitor electrode may be located within a space provided in the first capacitor electrode such that the first capacitor electrode surrounds the second capacitor electrode. The capacitor electrodes may optionally have a common centre-point such that they adopt a co-axial and concentric arrangement. These concentric-like arrangements further help to ensure that the current flow in the surface of the workpiece is localized, in this case to the area bounded by the outer first capacitor electrode.

Optionally, the surface area of the first and second capacitor electrodes are substantially the same. This ensures that the two capacitors formed between the capacitor electrodes and the workpiece have substantially the same capacitance.

Preferably, the apparatus further comprises an alternating current power supply. This alternating current power supply may be operable to supply high-voltage power and, in addition, may optionally supply power at radio frequencies. In a presently preferred embodiment, the power supply is operable to apply equal but opposite voltages to the first and second capacitor electrodes simultaneously. This helps further to minimize stray currents flowing away from the part of the surface that faces the first and second capacitor electrodes.

Optionally, a dielectric is provided to face the first and second capacitor electrodes. Conveniently, a common dielectric may face both the first and second capacitor electrodes.

Preferably, the second capacitor electrode has a central aperture that houses a gas supply conduit or a gas extraction conduit. This may be useful because in some surface treatments (e.g. surface cleaning by radical oxidation, or surface coating) it may be desirable to have a gas flow through the plasma processing zone to replenish used species and/or to carry away waste products. Optionally, the first and second capacitor electrodes are housed within an earthed enclosure. This further reduces the possibility of stray currents and protects users from the chances of electrical shock. Conveniently, the earthed enclosure forms part of a gas extraction conduit. In this way, gas may be introduced into the plasma processing zone through the centre of the inner second capacitor electrode before passing through the plasma processing zone and being extracted through one or more apertures left between the outside of the outer first capacitor electrode and the earthed enclosure.

Optionally, the first or second capacitor electrode has an associated cooling system. The first and second capacitor electrodes may be liquid cooled, e.g. water cooled. Conveniently, a coolant inlet conduit is housed within a gas supply conduit and/or a coolant outlet conduit is housed within a gas extraction conduit. The electrical connector may also be housed in the gas supply conduit and/or the gas extraction conduit. This results in a compact design.

From a second aspect, the invention resides in a method of treating a surface using a plasma discharge comprising the steps of: bringing the apparatus described above into the proximity of the surface to be cleaned such that the first and second capacitor electrodes face the surface, any dielectric being interposed between capacitor electrode and surface, and applying a voltage across the first and second capacitor electrodes thereby causing a current to flow across a first capacitor formed by the first capacitor electrode and the surface, the current then to flow along the surface and exit by flowing across a second capacitor formed by the surface and the second capacitor electrode, such that current flows across the first and second capacitors causes a plasma discharge thereby treating the surface. Optionally, equal and opposite voltages are applied to the first and second capacitor electrodes simultaneously. The invention also resides in a surface treated according to such a method and to a vehicle comprising such a surface.

### BRIEF DESCRIPTION OF THE DRAWINGS

In order that the present invention can be more readily understood, reference will now be made by way of example only, to the accompanying drawings in which;

FIG. 1a is a schematic diagram of a surface-treatment apparatus according to the prior art;

FIG. 1b is a simplified circuit diagram of the surface-treatment apparatus of FIG. 1a;

FIG. 2a is a schematic diagram of a surface-treatment apparatus according to a first embodiment of the present invention;

FIG. 2b is a simplified circuit diagram of the surface-treatment apparatus of FIG. 2a;

FIG. 3 is a perspective view of the surface-treatment apparatus of FIG. 2a;

FIG. 4 is a plan view of a twin-electrode arrangement of a surface-treatment apparatus according to a second embodiment of the present invention;

FIG. 5 is a cross-sectional view of the surface-treatment apparatus according to the second embodiment of the present invention;

FIG. 6 is a cross-sectional view of a surface-treatment apparatus according to a third embodiment of the present invention;

FIG. 7 is a cross-sectional view of a surface-treatment apparatus according to a fourth embodiment of the present invention;

FIG. 8(a) is a schematic diagram of a surface-treatment apparatus for treating a surface curved in two directions;

FIG. 8(b) is a cross-sectional view of the electrodes of the apparatus of FIG. 8(a);

FIG. 9(a) is a schematic diagram in front view of a surface-treatment apparatus for treating a surface curved in one direction; and

FIG. 9(b) is a side view of FIG. 9(a).

### DETAILED DESCRIPTION

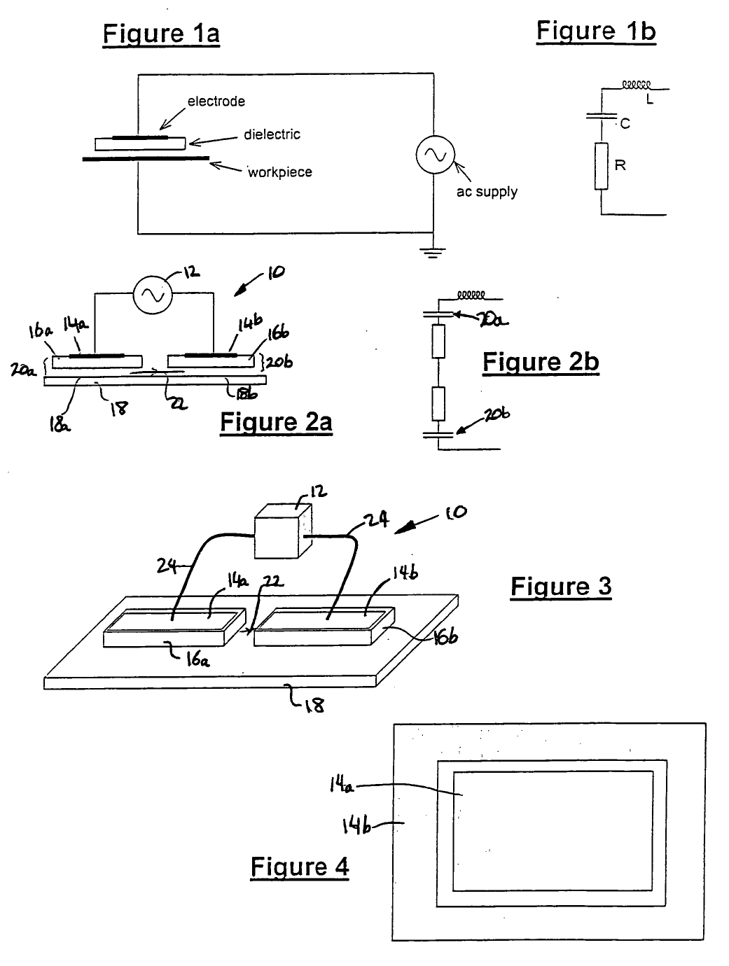

An apparatus for treating a surface according to the prior art is shown in FIG. 1a. The apparatus comprises an electrode mounted on a dielectric slab. The dielectric slab is brought close to the surface of a workpiece to be cleaned. A first terminal of a high-voltage ac power supply is connected to the electrode and a second terminal is connected directly to the workpiece. When operating, current flows across the capacitive gap between electrode and workpiece via breakdown thereby giving a discharge plasma. This circuit can be represented simply by an inductor L, a capacitor C and a resistor R, as indicated in FIG. 1b. The capacitance is derived from the capacitance of the electrical leads and that of the gap between electrodes and workpiece, the inductance is primarily due to that of the electrical leads, and the resistance is mainly caused by the plasma impedance and by dielectric losses.

FIGS. 2a and 3 show an apparatus for treating a surface according to a first embodiment of the present invention. The apparatus 10 comprises an ac power supply 12 connected to a pair of capacitor electrodes 14 that are arranged to be side-by-side. The electrodes 14 are planar and rectangular in cross-section and are the same size. Similarly shaped, but larger dielectric slabs 16 are attached to the electrodes 14. The electrodes 14 are brought close to the surface 18 of a workpiece such that the electrical circuit illustrated in FIG. 2b is formed. As can be seen, the first electrode 14a and the part 18a of the surface immediately thereunder form a first capacitor 20a, the second electrode 14b and the part 18b of the surface immediately thereunder form a second capacitor 20b, the first and second capacitors 20 being electrically connected along a path 22 across the surface 18 between the parts of the surface 18a,b under the first and second electrodes 14 respectively. This circuit is true where the separation between dielectric slabs 16 and the surface 18 is smaller than the separation between the dielectric slabs 16. To avoid electrical breakdown between the electrodes 14, the electrodes 14 may be coated with a dielectric 16 and/or a sufficient air-gap can be left between the electrodes 14.

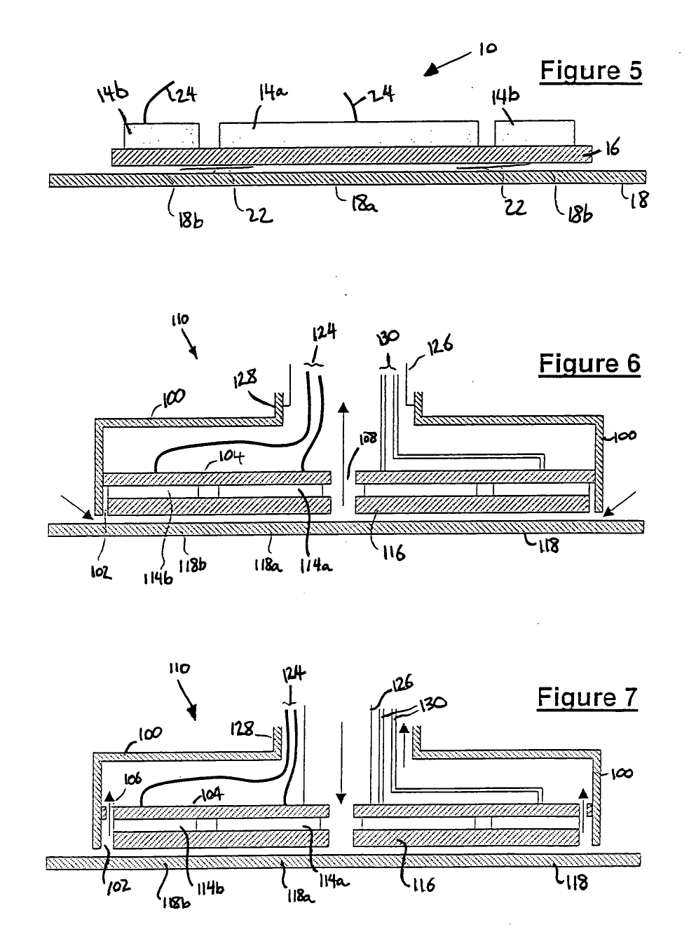

A simple side-by-side arrangement of two electrodes 14 is shown in FIGS. 2a and 3. An alternative arrangement is shown in FIG. 4 where an inner electrode 14a and an outer electrode 14b are employed. The inner electrode 14a is a regular rectangle in cross-section, but the outer electrode 14b is an annular rectangle in cross-section. The hole in the centre of the outer electrode 14b is large enough to accommodate the inner electrode 14a in a co-axial and co-planar fashion. As can be seen from the cross-sectional view of FIG. 5, the electrodes 14 are attached to a common dielectric slab 16 that is also rectangular in shape but slightly larger in extent than the outer electrode 14b. When brought close to a surface of a workpiece 18, a circuit equivalent to that shown in FIG. 2b is formed with current flowing through the surface 18 from the part 18a immediately under the inner electrode 14a to the part 18b immediately under the outer electrode 18b, or vice versa as the polarity of the power supply 12 reverses (and the power supply 12 is not shown in FIG. 5, although the ends of the electrical connector 24 linking electrodes to power supply are shown).

An advanced embodiment of the present invention is shown in FIG. 6 that includes a coolant system and an air extractor. The embodiment of FIG. 6 builds on the embodiment of FIGS. 4 and 5, and so like parts have been accorded like reference numerals but incremented by 100 (such that the dielectric formerly referenced by 16 is now referenced by 116). In addition, like parts will not be described again to avoid unnecessary repetition.

The apparatus 110 of FIG. 6 shares the co-axial and co-planar electrode 114 arrangement of FIG. 4 and so forms a circuit equivalent to that shown in FIG. 2b when operated close to the surface 118 of a workpiece to be cleaned. The electrodes 114 of FIG. 6 are housed within an earthed housing 100. The housing 100 is co-terminus with the bottom of the dielectric slab 116, and is sized larger than the dielectric slab 116 thereby leaving an insulating air-gap 102 all around the periphery of the dielectric slab 116 and the outer electrode 114b. In this embodiment, the electrodes 114 are attached to an insulating mounting plate 104 that is, in turn, attached to the sidewalls of the housing 100.

A central circular aperture 108 is formed through the mounting plate 104, inner electrode 114a and dielectric slab 116. Moreover, a hose 126 is provided that clamps around a neck 128 provided in the top of the housing 100 in an airtight fashion such that it encloses the central aperture 108. This hose 126 is attached to an air extractor (not shown) such that air can be drawn through the plasma processing zone between the dielectric slab 116 and the surface 118 of the workpiece. Air enters from the sides of the apparatus 110, as indicated by the symmetrical arrows in FIG. 6, and replenishes used species and/or carries away waste products. The flow of air back through the apparatus 100 is indicated by the arrow in the centre of FIG. 6.

A cooling system is also provided for the electrodes 114. Cold water is passed to the inner 114a and outer 114b electrodes via a pair of inlet pipes 130 and back out via a pair of outlet pipes (only the inlet pipes 130 are shown in FIG. 6 for sake of clarity). As can be seen from FIG. 6, the electrical connections 124 to the power supply 112, the coolant inlet 130 and outlet pipes, are all routed through the air extractor hose 126 within the neck 128. This allows a single umbilical tube to link the head of the apparatus 110 (i.e. the components shown in FIG. 6) to a remote location housing the power supply 112, air extractor and coolant supply. This means that the head of the apparatus 110 is relatively lightweight and compact and so can be easily moved around a surface 118 to be treated.

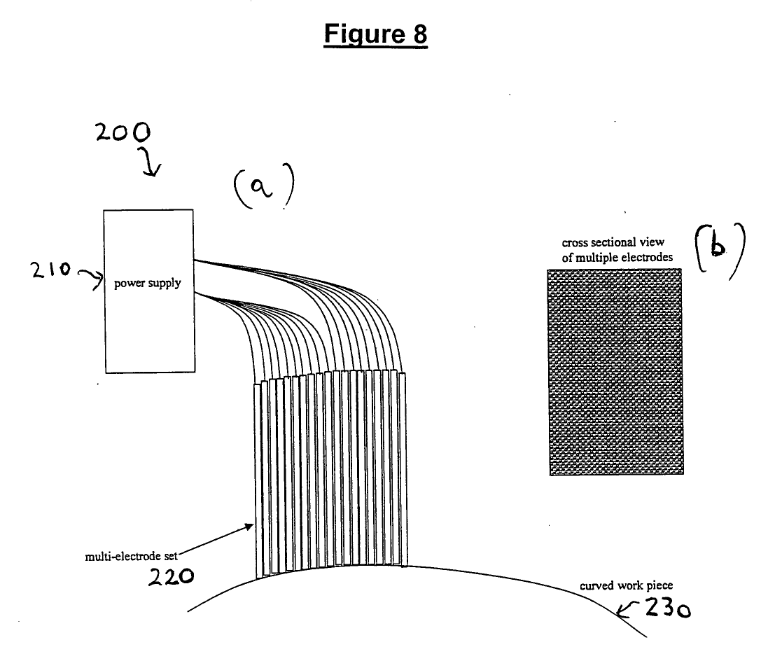

A further embodiment of the present invention is shown in FIG. 7 that includes a gas delivery and extraction system rather than just an air extractor. This apparatus 110 is suitable where it is desired to have a certain gas or gases in the plasma processing zone, e.g. for deposition onto the surface 118. The embodiment of FIG. 7 is very similar to the embodiment of FIG. 6, and so like parts have been accorded like reference numerals and like parts will not be described again to avoid unnecessary repetition.

The apparatus 110 of FIG. 7 shares the co-axial and co-planar electrode 114 arrangement of FIG. 4 and so forms a circuit equivalent to that shown in FIG. 2b when operated close to the surface 118 of a workpiece to be treated. In this embodiment, the insulating mounting plate 104 contains a plurality of holes 106 that lie above the gap 102 formed between the outer electrode 114b/dielectric slab 116 and the housing 100. This arrangement allows gas to circulate freely from the plasma processing zone between the dielectric slab 116 and the workpiece 118 into the interior of the housing 100.

As in FIG. 6, a central circular aperture 108 is formed through the mounting plate 104, inner electrode 114a and dielectric slab 116. In addition, the hose 126 is also provided to extend through the neck 128 to attach to the top of the mounting plate 104 in an airtight fashion such that it encloses the central aperture 108. This hose 126 is now attached to a gas supply system (not shown) such that a gas or gas mixture (e.g. He/O₂) can be passed into the housing 100, through the central aperture 108 and into the plasma processing zone between the dielectric slab 116 and the surface 118. The gas replenishes used species and/or carries away waste products. The gas can be extracted from the plasma processing zone via the gap 102 provided to the sides of the dielectric slab 116/outer electrode 114b and through the holes 106 in the mounting plate 104 and out via the neck 128 of the housing 100. The flow of gas through the apparatus 100 is indicated by the arrows in FIG. 7. The gas can be extracted from the apparatus 110 via a suction unit (not shown) attached directly to the neck 128 of the housing 100.

More specific details regarding the apparatus of FIG. 7 are given below. The electrodes 114 are made of brass and contain internal water-cooling channels to which the inlet 130 and outlet pipes connect. The electrodes 114 may be attached to the plastic mounting plate 104 in any number of conventional ways. Similarly, attaching the electrodes 114 to the dielectric slab 116 can be made in a variety of conventional ways, although using a spray-on adhesive is preferred. The dielectric 116 is a slab of alumina measuring 120 mm×120 mm×0.5 mm. The housing 100 is made from aluminum and has four insulating castors attached to its base (not shown). The height of these castors is adjustable so that a desired separation of dielectric slab 116 from workpiece 118 can be achieved by placing the castors against the surface 118 of the workpiece. Separations of 0.1-0.5 mm have been found particularly effective. In order to stop breakdown between the electrodes 114, they are separated by a gap of 7 mm around their edges (of course, the corner-to-corner distance is larger). Likewise, a gap between the outer electrode 114b and the earthed housing 100 must be maintained, and a separation of 4 mm has been found to work well. The inner electrode 114a is inset between the mounting plate 104 and dielectric slab 116 to prevent electrical breakdown to the workpiece 118, and a gap of 5 mm between the edge of the inner electrode 114a and the edges of the dielectric slab 116 is used in this embodiment. This results in an overall size for the head of the apparatus of 130 mm×130 mm×45 mm. The ac supply 112 operates at a peak voltage of ±6 kV at a radio frequency of 84 kHz.

The person skilled in the art will appreciate that modifications can be made to the embodiments described hereinabove without departing from the scope of the invention.

For example, the shape of the electrodes 14; 114 is largely an arbitrary choice, whether they be co-axially arranged or in a simple side-by-side arrangement. Other simple geometrical shapes such as squares, circles, hexagons, etc. may be used. Where a co-axial arrangement is used, the two electrodes 14; 114 need not be the same shape. As noted above, it is advantageous for the surface areas presented by the electrodes 14; 114 to the surface 18; 118 to be equal.

The position of the holes 102, 106, 108 for allowing gas to be passed into and out from the plasma processing zone is largely arbitrary as is whether the gas passes into the centre and out from an edge or vice versa. The choice of gas to be used can be freely made. Suitable gases include helium and hydrocarbon gases including fluorinated hydrocarbons. A chemical monomer such as GMA may be used with a carrier gas such as nitrogen: the monomer may polymerize in the plasma to be deposited on the surface 18; 118. Silicon organic compounds such as TEOS may also be used with a carrier gas such as nitrogen to obtain SiO₂ deposition on the surface 18; 118.

Water cooling is a convenient form of cooling the electrodes 14; 114. Gas cooling may also be used to cool the electrodes 14; 114.

Rather than having a single pair of electrodes 14; 114, a plurality of pairs of electrodes 14; 114 could be used. The electrodes 14; 114 may all be arranged co-axially or they may be arranged in an array (e.g. the arrangement of FIG. 4 may be repeated to form a 3×3 grid of pairs of co-axial electrodes).

While routing all connections through the neck 128 of the enclosure 100 is convenient, it is by no means essential and separate connectors could be provided on the exterior of the housing 100 for the electrical, gas and coolant supplies.

It is not essential to provide voltages of equal and opposite polarities to the electrodes 14; 114, although it is preferred due to the decrease in stray currents that this provides. Sinusoidal ac signals are not essential and any alternating polarity signal that produces a discharge plasma is suitable, for example a pulsed signal with a suitable repetition frequency.

It is to be further appreciated from the above described arrangements that such arrangements are not envisaged to treat curved surfaces effectively, because only a small portion of the overall electrode area is sufficiently close to the workpiece for a plasma to form there. The inventors have now recognized how this particular technical problem can be overcome in two distinct ways—which way to be used is dependent upon the nature of the curved surface (whether it is curved in one direction or two) as will be described in more detail hereinafter.

FIG. 8(a) is a schematic diagram of a surface treatment apparatus for treating a surface curved in two directions. As can be seen from FIG. 8(a), the apparatus 200 comprises a power supply 210 connected to a multi-electrode set 220 that in turn is mounted in proximity to the curved surface of a workpiece 230 to be treated. The individual electrodes 220 are held in a bundle. The electrodes can have any cross-sectional shape. As shown, the connections to the power supply 210 are made for groups of electrodes. Alternatively (not shown), the connections to the power supply could be made for alternating electrodes, if desired. As also shown in the Figure, the processing head is placed on the curved workpiece 230. In this way, under the influence of some force (by gravity, compressed air or springs for example), the electrodes adjust to the curved surface profile. This means that a higher area percentage of the surface can be treated.

In FIG. 8(a), the individual electrodes 220 can be made of bare metal or of ceramic coated metal. Bare metal is the preferred choice of electrode material because it is easy to use and is cheap. It is to be understood that the tips of the electrodes 220 that are arranged to be in proximity to the curved workpiece 230 must be coated in a layer of suitable insulating material. In operation of the apparatus of FIG. 8(a), the plasma will thus form between this layer of insulating material and the workpiece. This insulating material could be ceramic material (alumina or titania for example).

FIG. 8(b) is a cross-section view of the multiple electrodes 220 of FIG. 8(a).

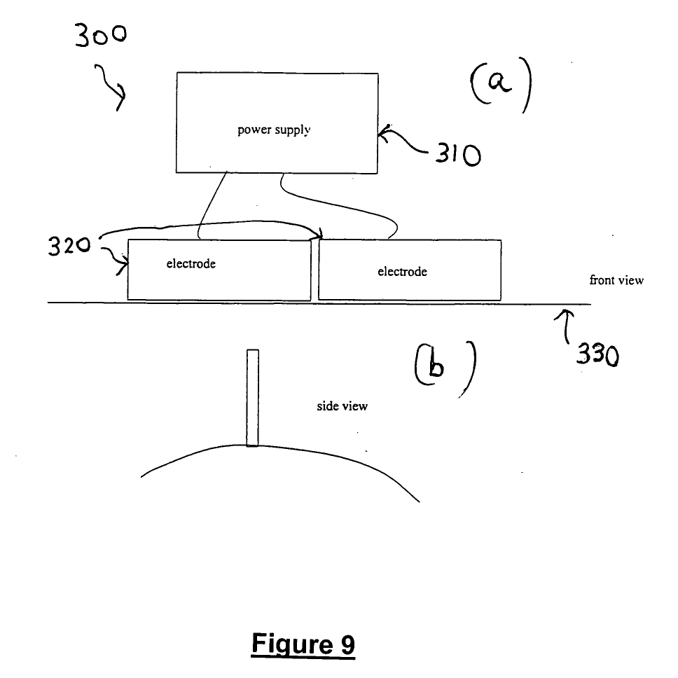

It is to be understood that the apparatus 200 of FIGS. 8(a), (b), could equally be used for treating a surface curved in one direction. An alternative arrangement for treating a surface curved in one direction is further shown in front view in FIG. 9(a). As shown in the Figure, the apparatus 300 comprises a power supply 310 connected to a pair of electrodes 320 that are arranged to be side-by-side. As shown, the electrodes 320 are brought close to the surface of the workpiece 330 to be treated. The two electrodes are formed so as to present a narrow profile to the curved direction and the variation of distance to the workpiece is consequently small. Note that the curved direction of the workpiece is shown in FIG. 9(b) which corresponds to a side view of FIG. 9(a).

What is claimed is:

1. An apparatus for treating a surface using a plasma discharge comprising:
a first capacitor electrode of a first capacitor;
a second capacitor electrode of a second capacitor; and
an electrical connection for connecting the first capacitor electrode to the second capacitor electrode;
wherein the first capacitor electrode and second capacitor electrode are disposed in juxtaposition.

2. The apparatus according to claim 1, wherein the first capacitor electrode is disposed entirely to one side of the second capacitor electrode.

3. The apparatus according to claim 1, wherein the second capacitor electrode is located within a space provided in the first capacitor electrode such that the first capacitor electrode surrounds the second capacitor electrode.

4. The apparatus according to claim 3, wherein the second capacitor electrode has a central aperture that houses a gas supply conduit or a gas extraction conduit.

5. The apparatus according to claim 4, wherein the first and second capacitor electrodes are housed within an earthed enclosure.

6. The apparatus according to claim 5, wherein the earthed enclosure forms part of a gas extraction conduit.

7. The apparatus according to claim 1, wherein the surface area of the first and second capacitor electrodes are substantially the same.

8. The apparatus according to claim 1, further comprising an alternating-current power supply.

9. The apparatus according to claim 8, wherein the power supply is operable to apply equal but opposite voltages to the first and second capacitor electrodes simultaneously.

10. The apparatus according to claim 1, wherein a dielectric is provided to face the first and second capacitor electrode.

11. The apparatus according to claim 10, wherein a common dielectric faces both the first and second capacitor electrode.

12. The apparatus according to claim 1, wherein the first or second capacitor electrode has an associated cooling system.

13. The apparatus according to claim 12, wherein a coolant inlet conduit is housed within a gas extraction conduit and/or a coolant outlet conduit is housed within a gas extraction conduit.

14. A method of treating a surface using a plasma discharge apparatus having a first capacitor electrode of a first capacitor, a second capacitor electrode of a second capacitor, the second capacitor electrode disposed in juxtaposition with the first capacitor electrode, and an electrical connection for connecting the first capacitor electrode to the second capacitor electrode, the method comprising:
bringing the apparatus into proximity with the surface to be treated such that the first and second capacitor electrodes face the surface; and
applying a voltage across the first and second capacitor electrodes to induce a current to flow across a first capacitor formed by the first capacitor electrode and the surface, the current flowing along the surface and exiting the surface by flowing across a second capacitor formed by the surface and the second capacitor electrode, wherein the current flowing across the first and second capacitors causes a plasma discharge for treating the surface.

15. The method of claim 14, comprising:
interposing a dielectric between the first and second capacitor electrodes and the surface to be treated.

16. The method according to claim 14, comprising:
applying equal and opposite voltages to the first and second capacitor electrodes simultaneously.

17. A surface treated in accordance with the method of claim 14.

18. The surface of claim 17, wherein the surface is curved in at least one direction.

19. The surface of claim 17, wherein the surface is curved in two predefined directions.

20. A vehicle comprising a surface according to claim 17.
